(19) United States
(12) Patent Application Publication
(10) Pub. No.: US 2025/0075093 A1
(43) Pub. Date: Mar. 6, 2025

(54) THERMALLY STABLE CROSSLINKED POLYVINYL FLUORIDE COATING

(71) Applicant: DUPONT ELECTRONICS, INC., WILMINGTON, DE (US)

(72) Inventors: MICHAEL THOMAS DEMKO, BEAR, DE (US); DONALD DOUGLAS MAY, CHADDS FORD, PA (US); KAUSHIK ROY CHOUDHURY, GARNET VALLEY, PA (US); YIYUAN YIN, HOCKESSIN, DE (US)

(21) Appl. No.: 18/804,565

(22) Filed: Aug. 14, 2024

Related U.S. Application Data
(60) Provisional application No. 63/580,021, filed on Sep. 1, 2023.
(60) Provisional application No. 63/579,791, filed on Aug. 30, 2023.

(51) Int. Cl. C09D 127/14; C09D 5/00; C09D 7/48; C09D 7/63; C09D 133/04; C09D 167/00; C09D 175/04

(52) U.S. Cl. CPC C09D 127/14; C09D 5/002; C09D 7/48; C09D 7/63; C09D 133/04; C09D 167/00; C09D 175/04

(57) ABSTRACT

The present disclosure relates to a coating composition comprising polyvinyl fluoride (PVF), an acrylic copolymer comprising amine and/or hydroxyl functional groups, and an isocyanate or melamine crosslinker with groups that are reactive towards amine or hydroxyl groups. Also disclosed herein are dried or cured coatings resulting from the coating composition, substrates coated with such coating compositions, the resulting dried and/or cured coated substrates, and methods of coating such substrates.

### FIELD

The present disclosure relates to polyvinyl fluoride coatings capable of adhesion to a wide range of primers and bare metals.

### BACKGROUND

Polyvinyl fluoride (PVF) films are laminated to metal to provide aesthetics and durable protection for metal from harsh environmental conditions such as UV radiation, moisture, and corrosive environments such as exposure to acidic and basic conditions. However, PVF films are only available in a limited selection of colors, can only be produced in large batch sizes, and require adhesive to adhere to a substrate. Compared to PVF films, coatings made from PVF resin retain much of the same protection and durable aesthetics but can operate in smaller batch size, are easier to apply to the substrate surface and provide a wider selection of aesthetic options. However, due to the inert property of the PVF polymer, PVF coatings are only able to adhere to limited types of primers and cannot adhere to bare metal.

Limited thermal stability is another issue in PVF polymers. In the PVF coating process, a PVF dispersion must be heated to a desirable temperature to coalesce the PVF resin and evaporate the solvent to form a uniform coating. However, if the PVF resin remains at a high temperature for a long time, the PVF polymer begins to decompose, which makes the PVF coating appear yellow. Enhanced thermal stability is desirable to more easily achieve well-coalesced coatings in a variety of ovens and oven conditions.

The simplest solution for improving adhesion of a PVF coating is to add acrylics or additional acrylics to the formulation. However, this approach can sacrifice the desired properties of PVF coatings such as flexibility, chemical resistance, and weatherability.

PVF coating adhesion can also be improved by using a primer, or by engineering the primer. Adding a certain amount of PVF resin to the primer may improve the PVF topcoat adhesion, because this could increase the wettability of PVF topcoat on the primer and possibly increase the mechanical interlocking and intermolecular hydrogen bonding. However, the development of a PVF-containing primer can be complicated and may increase the cost due to the additional amount of PVF resin used.

Adhesion can also be improved by tuning the process conditions, especially underbaking the primer in the primer curing process. This approach potentially increases the diffusion of components in the primer into the topcoat thereby increasing the topcoat to primer adhesion. However, this can sacrifice the desired chemical resistance as the diffused components may change the topcoat composition.

In the publications “Tailoring Crosslink Density and Index in 2K Waterborne PVDF Coatings” (Beaugendre et al., Coatingstech 11(7), 2014) and “A New Approach to Water-based Fluoropolymer-urethane Hybrid Coatings” (Gupta et al., Proc. 2010 American Coatings Conference, Charlotte, NC, Apr. 12-14, 2010), the authors reported a polyvinylidene fluoride (PVDF)/acrylics resin that can be crosslinked by isocyanates and described that enhanced adhesion can be achieved using the isocyanate crosslinking chemistry. They also described that this crosslinkable PVDF/acrylics system could be applied and adhere to different window profile substrates such as primed aluminum, polyester fiber glass composite, and vinyl.

Thermal stability of thick PVF product produced from a compression molding or ram extrusion process may possibly be improved by adding epoxide, hindered phenolic compound, alkyl aryl phosphite, and/or mercaptoarylimidazole (see, e.g., U.S. Pat. No. 5,447,975). Other fluoropolymers (e.g., PVDF) used in coating process have strong stability due to their more fluorinated polymer structure, which requires lower levels of thermal stabilizers in the formulation.

There thus remains a need for improving the adhesion of PVF coatings to a large range of primer materials as well as to bare metal, while maintaining the coatings' other favorable properties.

### SUMMARY

One aspect is for a coating composition comprising a polyvinyl fluoride (PVF), an acrylic copolymer comprising amine and/or hydroxyl functional groups, and an isocyanate or a melamine crosslinker with reactive groups that react with amino or hydroxyl functional groups; wherein the weight ratio of the acrylic copolymer to the PVF is in the range of about 0.05:1 to about 0.25:1; and wherein the number of reactive groups in the isocyanate or melamine crosslinker is about 75 to about 125 mol % relative to the total number of amine or hydroxyl functional groups in the acrylic copolymer. In some embodiments, the coating composition further comprises a pigment component, wherein the weight ratio of the pigment component to the total weight of PVF and acrylic copolymer in the coating composition is in a range of about 0.05:1 to about 0.25:1. In some embodiments, the coating composition further comprises an acid scavenger epoxide component wherein the weight ratio of the acid scavenger epoxide component to the PVF is in the range of about 0.002:1 to about 0.1:1. In some embodiments, the coating composition further comprises an antioxidant component wherein the weight ratio of antioxidant component to the PVF is in the range of about 0.002:1 to about 0.1:1; and in some embodiments, the antioxidant component is a phosphate-based antioxidant or a phenolic antioxidant. In some embodiments, the coating composition further comprises one or more solvents wherein the weight ratio of the solvents to the PVF is in the range of about 2:1 to about 1:1.

An additional aspect is for a coating composition comprising (a) about 25 wt % to about 35 wt % polyvinyl fluoride (PVF), (b) about 3 wt % to about 10 wt % of an acrylic copolymer comprising amine and/or hydroxyl functional groups, and (c) about 75 mol % to about 120 mol % of an isocyanate or a melamine crosslinker reactive groups relative to the amine and/or hydroxyl functional groups of the acrylic copolymer. In some embodiments, the coating composition further comprises a weight ratio of a pigment component to the total amount of PVF and acrylic copolymer in the coating composition in a range of about 0.05:1 to about 0.25:1. In some embodiments, the coating composition further comprises about 0.5 wt % to about 5 wt % of an acid scavenger epoxide component. In some embodiments, the coating composition further comprises about 0.5 wt % to about 5 wt % of antioxidant component, and in some embodiments the antioxidant component is a phosphate-based antioxidant or a phenolic antioxidant. In some embodiments, the coating composition further comprises about 40 wt % to about 60 wt % of one or more solvents.

Another aspect is for a substrate at least partially coated by one of the aforementioned coating compositions. In some embodiments, the substrate is a primer, and in some embodiments the primer is a polyurethane, a polyester, or an acrylic primer. In some embodiments, the substrate is a metal. In some embodiments, the substrate is a cured layer of the aforementioned coating composition. In some embodiments, the coating composition is cured on the substrate.

A further aspect is for a method of coating a substrate comprising applying the aforementioned coating composition to at least a portion of the substrate. In some embodiments, the substrate is coil coated with the coating composition.

Another aspect is for a dry coated film composition comprising a PVF, an acrylic copolymer comprising amine and/or hydroxyl functional groups, and an isocyanate or a melamine crosslinker reactive groups that react with amino or hydroxyl functional groups; wherein the weight ratio of the acrylic copolymer to the PVF is in the range of about 0.05:1 to about 0.25:1; and wherein the number of reactive groups in the isocyanate or melamine crosslinker is about 75 to about 125 mol % relative to the total number of amine or hydroxyl functional groups in the acrylic copolymer. In some embodiments, the dry coated film composition is coated on at least a portion of a primed substrate or a metal substrate; and in some embodiments, the primer is a polyurethane, a polyester, or an acrylic primer. In some embodiments, the dry coated film composition results from one of the aforementioned coated substrates. In some embodiments, the dry coated film composition is cured.

An additional aspect is for a dry coated film composition comprising (a) about 50 wt % to about 70 wt % PVF, (b) about 5 wt % to about 20 wt % of an acrylic copolymer comprising amine and/or hydroxyl functional groups, and (c) about 75 mol % to about 120 mol % of an isocyanate or a melamine crosslinker reactive groups relative to the amine and/or hydroxyl functional groups of the acrylic copolymer. In some embodiments, the dry coated film composition is cured.

Other objects and advantages will become apparent to those skilled in the art upon reference to the detailed description that hereinafter follows.

### DETAILED DESCRIPTION

The presently disclosed coating compositions improve the adhesion of PVF coatings when applied to a larger range of primer materials as well as to bare metal. A coating made with PVF resin enables a metal coil coater to offer a similar level of protection from UV light and corrosive environments in a much more versatile format than PVF films. Custom colors can be created in smaller batch sizes and applied to a metal coil with or without a corrosion-resistant primer.

The presently disclosed thermally stable crosslinked PVF coating formulation comprises isocyanate or melamine as a crosslinking agent and optionally an acid scavenger expoxide component and/or an antioxidant component as a thermal stabilizer. Isocyanate or melamine can react with amine or hydroxyl groups on the substrate surface as well as amine or hydroxyl groups in functionalized acrylics to form a covalent-bonded polymeric matrix. This formation of covalent bonds provides stronger adhesion of the PVF coating to the substrate surface compared to PVF coatings without crosslinking. The crosslinking in the PVF matrix also makes the polymer difficult to extract with an organic solvent such as methyl ethyl ketone (MEK). The optional thermal stabilizers make the PVF stable at high curing temperature and for an extended curing time.

Acrylic resin is known to be soluble in PVDF, whereas it is not soluble in PVF. Here, it is expected that the acrylic forms a separate microstructure in the PVF coating relative to the PVDF coating. The result is a well-adhered coating that retains the chemical resistance and flexibility benefits of PVF, which are superior to those of PVDF.

### Definitions

In this disclosure, a number of terms and abbreviations are used. The following definitions are provided.

As used herein, the term “about” or “approximately” means within 20%, 19%, 18%, 17%, 16%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1% or less of a given value or range.

The term “comprising” is intended to include embodiments encompassed by the terms “consisting essentially of” and “consisting of”. Similarly, the term “consisting essentially of” is intended to include embodiments encompassed by the term “consisting of”.

The indefinite articles “a” and “an”, as used herein in the specification and in the claims, unless clearly indicated to the contrary, should be understood to mean “at least one”.

The phrase “and/or”, as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B”, when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of”, or, when used in the claims, “consisting of”, will refer to the inclusion of exactly one element of a number or list of elements. In general, the term “or” as used herein shall only be interpreted as indicating exclusive alternatives (i.e., “one or the other but not both”) when preceded by terms of exclusivity, “either”, “one of”, “only one of”, “exactly one of”. “Consisting essentially of”, when used in the claims, shall have its ordinary meaning as used in the field of patent law.

As used herein, the term “polyvinyl fluoride” or “PVF” includes homopolymers of vinyl fluoride and also embraces copolymers of vinyl fluoride with other monoethylenically unsaturated monomers copolymerizable therewith, wherein vinyl fluoride repeat units constitute at least about 75% of the total copolymer weight. Representative monoethylenically unsaturated monomers useful for this purpose include vinyl esters, such as acetate and stearate, acrylates and methacrylates, such as methyl, ethyl, butyl, and isobutylene methacrylate. Other useful monomers are listed in U.S. Pat. No. 3,139,470. PVF can be prepared as described in U.S. Pat. No. 3,139,207 and can be manufactured in oriented film form as described in U.S. Pat. No. 3,139,470.

### PVF Coatings

Some embodiments are directed to coating compositions comprising a PVF, an acrylic copolymer comprising amine and/or hydroxyl functional groups, and an isocyanate or a melamine crosslinker with reactive groups that react with amino or hydroxyl functional groups; wherein the weight ratio of the acrylic copolymer to the PVF is in the range of about 0.05:1 to about 0.25:1; and wherein the number of reactive groups in the isocyanate or melamine crosslinker is about 75 to about 125 mol % relative to the total number of amine or hydroxyl functional groups in the acrylic copolymer.

Some embodiments are directed to coating compositions comprising about 25 wt % to about 35 wt % PVF, about 3 wt % to about 10 wt % of an acrylic copolymer comprising amine and/or hydroxyl functional groups, and about 75 mol % to about 120 mol % of an isocyanate or a melamine crosslinker reactive groups relative to the amine and/or hydroxyl functional groups of the acrylic copolymer.

PVF resin is generally not soluble at room temperature in conventional solvents; however, it can be dispersed in so-called latent solvents. A dispersion of PVF powder is suspended in latent solvent and heated to a first temperature at which a gel is formed and then to a higher second temperature at which a solution is formed. Latent solvents and other technology useful in handling PVF are discussed in U.S. Pat. Nos. 2,953,818 and 3,139,470.

Such latent solvents have inappreciable solvent action for PVF at temperatures below about 90° C., but show solvent action for PVF at higher temperatures. The latent solvents are relatively volatile since, in general, their boiling point is between about 90° C. and 300° C. In some embodiments, latent solvents are substantially removed by heating at 200° C. or less for about 20 minutes. During this heat treatment, water and any volatile nonsolvent is removed and the polymer particles are subjected to the action of an increasing concentration of latent solvent at a temperature at which the solvent is an effective solvent.

In some embodiments, the weight ratio of the acrylic copolymer to the PVF is in the range of about 0.05:1 to about 0.25:1, about 0.08:1 to about 0.22:1, about 0.10:1 to about 0.20:1, or about 0.14:1 to about 0.16:1. In some embodiments, the weight ratio of the acrylic copolymer to the PVF is about 0.05:1, about 0.10:1, about 0.15:1, about 0.20:1, or about 0.25:1.

In some embodiments, PVF is present in the coating composition in a range of about 25 wt % to about 35 wt %, about 26 wt % to about 34 wt %, about 27 wt % to about 33 wt %, about 28 wt % to about 32 wt %, or about 29 wt % to about 31 wt %. In some embodiments, PVF is present in the coating composition in amount of about 25 wt %, about 27 wt %, about 29 wt %, about 31 wt %, about 33 wt %, or about 35 wt %.

An acrylic copolymer for use in the present coating compositions is formed by the polymerization of acrylate monomers. Acrylate monomers are based on the structure of acrylic acid, which consists of a vinyl group and a carboxylic acid ester terminus. Typical acrylate monomers are acrylic acid, methyl acrylate, methyl methacrylate, ethyl acrylate, butyl methacrylate, and the like. Thus, the acrylic copolymer may comprise monomers of acrylic acid, methyl acrylate, methyl methacrylate, ethyl acrylate, and/or butyl methacrylate.

Various hydroxy-functional monomers can be used, and in some embodiments the present coating compositions use an hydroxyalkyl ester of a monocarboxylic acid, such as acrylic acid or methacrylic acid. The alkyl groups contemplated are primarily those containing from 2-4 carbon atoms and illustrated by ethyl, propyl, or butyl. In some embodiments, the hydroxy-functional monomer is 2-hydroxyethyl methacrylate. Hydroxy alkyl ethers, such as the hydroxyethyl ether of allyl alcohol, are also useful.

The hydroxy-functional copolymer is, in some embodiments, the copolymer produced by solution copolymerization in the presence of free-radical polymerization catalyst of monoethylenically unsaturated monomers including the required proportion of hydroxyalkyl acrylate. The other monomers are, in some embodiments, acrylic esters and methacrylic esters with alcohols containing from 1 to 12 carbon atoms, 1 to 9 carbon atoms, 1 to 6 carbon atoms, 1 to 3 carbon atoms, or 1 to 2 carbon atom. In some embodiments, the other monomers are at least about 50% of methyl methacrylate and the balance hydroxyethyl acrylate, and in some embodiments, from about 55% to about 65% methyl methacrylate, about 57% to about 63% methyl methacrylate, methyl methacrylate, or about 59% to about 61% methyl methacrylate, balance hydroxyethyl acrylate.

Various amine-functional monomers can be used, and in some embodiments the present coating compositions use an aminoalkyl ester of a monocarboxylic acid, such as acrylic acid or methacrylic acid. The alkyl groups contemplated are primarily those containing from 2-4 carbon atoms and illustrated by ethyl, propyl, or butyl. In some embodiments, the amino-functional monomer is 2-aminoethyl methacrylate.

The amine-functional copolymer is, in some embodiments, a copolymer produced by solution copolymerization in the presence of free-radical polymerization catalyst of monoethylenically unsaturated monomers including the required proportion of aminoalkyl acrylate. The other monomers are, in some embodiments, acrylic esters and methacrylic esters with amine containing from 1 to 12 carbon atoms, 2 to 10 carbon atoms, 4 to 10 carbon atoms, 6 to 10 carbon atoms, 8 to 10 carbon atoms, or 9 to 10 carbon atoms. In some embodiments, the other monomers are acrylic esters and methacrylic esters with amine containing 1, 2, 3, 4, 5, 6, 7, 8, 9, or 10 carbon atoms. In some embodiments, the other monomers are at least about 50% of methyl methacrylate and the balance aminoethyl acrylate, and in some embodiments, from about 55% to about 65% methyl methacrylate, about 57% to about 63% methyl methacrylate, about 58% to about 62% methyl methacrylate, or about 59% to about 61% methyl methacrylate, balance aminoethyl acrylate.

In some embodiments, the acrylic copolymer is present in the coating composition in a range of about 3 wt % to about 10 wt %, about 4 wt % to about 9 wt %, about 5 wt % to about 8 wt %, or about 6 wt % to about 7 wt %. In some embodiments, the acrylic copolymer is present in the coating composition in amount of about 3 wt %, about 4 wt %, about 5 wt %, about 6 wt %, about 7 wt %, about 8 wt %, about 9 wt %, or about 10 wt %.

The coating composition further comprises an isocyanate or a melamine crosslinker, in an amount sufficient to provide about 75 mol % to about 120 mol % of reactive groups relative to the amine and/or hydroxyl functional groups of the acrylic copolymer.

Non-limiting examples of isocyanate crosslinkers include monomeric polyisocyanates such as toluene diisocyanate, 4,4′-methylene-bis(cyclohexyl isocyanate), and isophorone diisocyanate. In some embodiments, the isocyanate crosslinker is a blocked polyisocyanate, which is a polyisocyanate in which isocyanate groups have reacted with a protecting or blocking agent to form a derivative that will dissociate on heating to remove the protecting or blocking agent and release the reactive isocyanate group. Some examples of suitable blocking agents for polyisocyanates include aliphatic, cycloaliphatic or aralkyl monohydric alcohols, hydroxylamines, and ketoximes.

Non-limiting examples of melamine crosslinkers include those sold by Cytec under the trade name CYMEL®, particularly the CYMEL® 301, 303, and 385 alkylated melamine-formaldehyde resins.

In some embodiments, crosslinker is present in the coating composition in a range of about 75 mol % to about 120 mol %, about 80 mol % to about 115 mol %, about 85 mol % to about 110 mol %, about 90 mol % to about 105 mol %, or about 95 mol % to about 100 mol % crosslinker reactive groups relative to the amine and/or hydroxyl functional groups of the acrylic copolymer. In some embodiments, the crosslinker is present in the coating composition in amount of about 75 mol %, about 80 mol %, about 85 mol %, about 90 mol %, about 95 mol %, about 100 mol %, about 105 mol %, about 110 mol %, about 115 mol %, or about 120 mol % crosslinker reactive groups relative to the amine and/or hydroxyl functional groups of the acrylic copolymer.

In some embodiments, the coating composition further comprises a pigment component. Suitable pigments can be inorganic or organic color powder with any color, which includes, but is not limited to, a white powder of titanium oxide, white pearl powder, or zinc sulfide, a black powder of cobalt-copper-manganese oxide, copper-manganese oxide, copper-manganese-iron oxide, or iron oxide, a yellow powder of titanium yellow or bismuth yellow, a green powder of cobalt green or chromium oxide, or a blue powder of cobalt-chromium-aluminum oxide or ultramarine. Common types of organic pigments can include azo pigments, lake pigments, phthalocyanine pigments, and quinacridone pigments. The color powder can be used individually or in combination to achieve the desired color. The primer and the finish layer may utilize a color powder of the same color. Alternatively, the primer and the finish layer may utilize different colored powders. For example, the primer can be white, gray, or pale yellow, and the finish layer can be a darker color to cover the color of the primer.

In some embodiments, the amount of the pigment component present in the coating composition provides a weight ratio of the pigment component to the total amount of PVF and acrylic copolymer in the coating composition that is in a range of about 0.05:1 to about 0.25:1, about 0.07:1 to about 0.23:1, about 0.09:1 to about 0.21:1, about 0.11:1 to about 0.19:1, about 0.13:1 to about 0.17:1, or about 0.14:1 to about 0.16:1. In some embodiments, the pigment component is present in the coating composition in a weight ratio of the pigment component to the total amount of PVF and acrylic copolymer in the coating composition of about 0.05:1, about 0.10:1, about 0.15:1, about 0.20:1, or about 0.25:1.

In some embodiments, the coating composition further comprises an acid scavenger epoxide component. Non-limiting examples of suitable acid scavenger epoxides include difunctional bisphenol A/epichlorohydrin derived epoxy resins and cycloaliphatic glycidyl ethers such as those sold by Miller-Stephenson Chemicals under the trade name EPON® and EPONEX®, particularly the EPON® 825, 826, 828, 830, 834, 1001F, 1002F, 1004F difunctional bisphenol A/epichlorohydrin derived epoxy resin, and EPONEX® 1510 cycloaliphatic glycidyl ether.

In some embodiments, the weight ratio of the acid scavenger epoxide component to the PVF is in the range of about 0.002:1 to about 0.1:1, about 0.002:1 to about 0.08:1, about 0.002:1 to about 0.05:1, about 0.002:1 to about 0.025:1, about 0.002:1 to about 0.015:1, about 0.002:1 to about 0.01:1, or about 0.002:1 to about 0.005:1. In some embodiments, the weight ratio of the acid scavenger epoxide component to the PVF is about 0.002:1, about 0.005:1, about 0.01:1, about 0.015:1, about 0.025:1, about 0.05:1, about 0.075:1, or about 0.1:1.

In some embodiments, the acid scavenger component is present in the coating composition in a range of about 0.5 wt % to about 5 wt %, about 1 wt % to about 4.5 wt %, about 1.5 wt % to about 4 wt %, about 2 wt % to about 3.5 wt %, or about 2.5 wt % to about 3 wt %. In some embodiments, the acid scavenger component is present in the coating composition in an amount of about 0.5 wt %, about 1 wt %, about 2 wt %, about 3 wt %, about 4 wt %, or about 5 wt %.

In some embodiments, the coating composition further comprises an antioxidant component. In some embodiments, the antioxidant component is a phosphate-based antioxidant or a phenolic antioxidant or a dialkyl ester of thiodipropionic acid. Non-limiting examples of suitable antioxidants include those sold by BASF under the trade name IRGANOX® and IRGAPHOS®, particularly the IRGANOX® 1010 and 1035 phenolic antioxidant, IRGANOX® PS800 and PS802 dialkyl ester of thiodipropionic acid, and IRGAPHOS® 168 phospate-based antioxidant. Phosphite ethers such as those sold by SI Group under the trade name WESTON® are also suitable examples, such as WESTON® TPP.

In some embodiments, the weight ratio of antioxidant component to the PVF is in the range of about 0.002:1 to about 0.1:1, about 0.005:1 to about 0.08:1, about 0.01:1 to about 0.06:1, about 0.015:1 to about 0.05:1, about 0.02:1 to about 0.04:1, In some embodiments, the weight ratio of antioxidant component to the PVF is about 0.002:1, about 0.005:1, about 0.01:1, about 0.025:1, about 0.05:1, about 0.075:1, or about 0.1:1.

In some embodiments, the antioxidant component is present in the coating composition in a range of about 0.5 wt % to about 5 wt %, about 1 wt % to about 4.5 wt %, about 1.5 wt % to about 4 wt %, about 2 wt % to about 3.5 wt %, or about 2.5 wt % to about 3 wt %. In some embodiments, the antioxidant component is present in the coating composition in an amount of about 0.5 wt %, about 1 wt %, about 2 wt %, about 3 wt %, about 4 wt %, or about 5 wt %.

In some embodiments, the coating composition further comprises one or more solvents. Examples of suitable latent solvents may include, but are not limited to, gammabutyrolactone, N,N-dimethylacetamide, N,N-dimethylformamide, dimethylsulfoxide, N-methyl-2-pyrrolidone, gamma-valerolactone, butadiene cyclic sulfone, tetramethylene sulfone, dimethyl sulfolane, hexamethylenesulfone, diallyl sulfoxide, dicyanobutene, adiponitrile, ethylene carbonate, propylene carbonate, 1,2-butylene carbonate, 2,3-butylene carbonate, isobutylene carbonate, trimethylene carbonate, N,N-diethylformamide, N,N-dimethyl-gamma hydroxyacetamide, N,N dimethyl gamma hydroxybutyramide, N,N-dimethylacetamide, N,Ndimethylmethoxyacetamide, N-methylacetamide, N-methylformamide, N,N-dimethylaniline, N,N-dimethylethanolamine, 2-piperidone, N-methyl-2-piperidone, 1-ethyl-2-pyrrolidone, Nisopropyl 2 pyrrolidone, S-methyl 2 pyrrolidone, beta-propiolactone, delta-valerolactone, alphaangelica lactone, beta-angelica lactone, epsilon-caprolactone, alpha, beta and gamma-substituted alkyl derivatives of gammabutyrolactone, gamma-valerolactone, delta-valerolactone, deltasubstituted alkyl derivatives of delta-valerolactone, tetramethyl urea, 1-nitropropane, 2-nitropropane, acetonyl acetone, acetophenone, acetyl acetone, cyclohexanone, diacetone alcohol, dibutyl ketone, isophorone, mesityl oxide, methylamyl ketone, 3-methyl-cyclohexanone, bis-(methoxymethyl)uron, methyl acetylsalicylate, diethyl phosphate, butyl carbitol, dimethyl phthalate, diethyl phthalate, ethyl acetoacetate, methylbenzoate, methylene diacetate, methyl salicylate, phenyl acetate, triethyl phosphate, tris(morpholino) phosphine oxide, Nacetylmorpholine, N-acetylpiperidine, isoquinoline, quinoline, pyridine, xylene, tris(dimethylamido) phosphate, or a combination thereof. In one or more embodiments, the latent solvent may include propylene carbonate, γ-butyrolactone, n-methyl pyrrolidone, dimethylacetamide, dimethylsulfoxide, isophorone, diethyl phthalate, dimethyl phthalate, dimethylformamide, or a combination thereof.

In one or more embodiments, the latent solvent can be mixed with another organic solvent to form a solvent system. For example, the additional organic solvent may include ethylene glycol monobutylether, butyl carbitol, dipropylene glycol butyl ether, propylene glycol methyl ether acetate (PMA), dibasic ester (DBE), toluene, xylene, trimethyl benzene, methylethylketone, or a combination thereof.

In some embodiments, the weight ratio of the one or more solvents to the PVF is in the range of about 2:1 to about 1:1, about 1.95:1 to about 1.05:1, about 1.9:1 to about 1.2:1, about 1.85:1 to about 1.3:1, about 1.8:1 to about 1.4:1. In some embodiments, the weight ratio of the solvents to the PVF is in the range of about 2:1, about 1.75:1, about 1.5:1, about 1.25:1, about 1.15:1, about 1.1:1, about 1.05:1, or about 1:1.

In some embodiments, the solvent(s) are present in the coating composition in a range of about 40 wt % to about 60 wt %, about 42 wt % to about 58 wt %, about 44 wt % to about 56 wt %, about 46 wt % to about 54 wt %, about 48 wt % to about 52 wt %, or about 49 wt % to about 51 wt %. In some embodiments, the solvent is present in the coating composition in an amount of about 40 wt %, about 45 wt %, about 50 wt %, about 55 wt %, or about 60 wt %.

The sum of the weight percentages of the components of the PVF coating composition is 100 wt %.

### Substrate

The present disclosure is also directed to a substrate at least partially coated by the aforementioned coating composition. In some embodiments, the coating composition is applied to at least about 1%, about 5%, about 10%, about 20%, about 50%, about 75%, about 90%, about 95%, about 99%, or more. In some embodiments, the coating composition is applied to an entire substrate.

Generally, as non-limiting examples, a thickness of a single “layer”, as deposited, whether identifiable as a layer or not, of the coating composition may be in a range from less than 1 nm to a few or several nanometers, e.g., about 0.1, 0.5, 1, 2, 5, or 10 nm, up to tens or hundreds of nm, e.g., up to or in excess of 50, 100, 500, 600, 800, 900 nm, 1 μm, 5 μm, 10 μm, 20 μm, 40 μm, 50 μm or more.

Thicknesses of individual layers of a coating may be the same, approximately the same, or may be different. Example coatings may include individual deposited layers that include a layer of clear coating on top of a pigmented coating.

In some embodiments, the substrate is a primer. Primers form a link between a substrate pre-treatment and the next layer coating. The composition of the primer will vary depending on the type of next layer used. Primers require compatibility with various pre-treatments and next-layer coat systems; therefore, in some embodiments they comprise a mixture of resin systems.

In some embodiments, the primer is a polyurethane, a polyester, or an acrylic primer. Non-limiting examples of primers include those sold by Sherwin Williams under the trade name Novaprime® and Pro Industrial®, particularly the Novaprime® PU polyurethane-based primer, Novaprime® 871 and HB polyester primer, and Pro Industrial™ Pro-Cryl® Universal Acrylic Primer.

In some embodiments, the substrate is a metal. The substrate may, e.g., be cold rolled steel, stainless steel, metallic coated steel (i.e., hot dip galvanized steel), aluminium, or the like. The metal may be in the form of a coil which may, in some embodiments, have a width of maximally 1.8 m, typically about 1.0 to 1.5 m. The metal substrate can, in some embodiments, have a thickness of between 0.17 mm to 3.0 mm. At these thicknesses, the metal can suitably be treated by a coil coating process such as the method according to the present disclosure. In some embodiments, the metal substrate has a thickness of between about 0.30 mm and about 1.50 mm, as this is, in some embodiments, an optimal thickness for a coil coating process.

When the PVF coating composition is applied to the metal substrate by other methods, such as, for example, flexographic coating, gravure coating, curtain coating, extrusion coating, or spray coating, the dimensions of the substrate are of less importance. In these methods, a thin metal substrate may not be required, or it may be reinforced, if necessary, during the coating process, as by a belt, cylinder, etc. Conversely, it may be feasible in non-continuous methods to apply the PVF coating composition to a thicker metal substrate.

The metal substrate may optionally be pre-treated, for example by degreasing, optionally followed by washing, rinsing, passivation, and drying, and/or pre-treatment may comprise chemical pre-treatment based on chrome VI, chrome Ill, or a chrome free passivant. Examples of chrome free passivants are titanium and/or zirconium compounds, particularly complex fluorides of these elements. The pre-treatments may include any suitable conversion coating.

In some embodiments, the substrate is a cured layer of the PVF coating composition described herein.

In some embodiments, the aforementioned PVF coating composition is cured on the substrate. In such embodiments, a presently disclosed coating composition is applied at least partially onto a surface of the substrate, which is to be coated by any suitable procedure designed to give a coating of the thickness desired, and then heat curing the applied coating composition under controlled conditions, in some embodiments, involving an initial heat step to vaporize the latent solvent.

In some embodiments, the coating composition is applied to the substrate in a coil coating line. Coil coating is a continuous and highly automated industrial process for efficiently coating coils of metal. More specifically, a coil coating process is one in which an organic or inorganic coating material is applied on a metal strip in a continuous process which includes cleaning, if necessary, and chemical pre-treatment of the metal surface and either one-side or two-side, single or multiple application of (liquid) paints or coating powders which are subsequently cured or/and laminated with permanent plastic films. The substrate is delivered as a coil, that is, as a lengthwise-wound strip, from the rolling mills. Standard coil weights vary, e.g., from 5-6 tons for aluminum and up to about 25 tons for steel. The coil is positioned at the beginning of the line, then unwound at a constant speed, passing through the various pre-treatment, coating, and curing processes before being recoiled. Two strip accumulators may be placed at the beginning and the end of the line enabling the work to be continuous. This allows new coils to be added (and finished coils removed) by a metal stitching or welding process without having to slow down or stop the line.

Because the metal is treated in a coil coating process before it is cut and formed, the entire surface is cleaned and treated, providing tightly bonded finishes with reduced effort, cost, and use of chemicals. Coil coated metal, or pre-coated metal, is more durable and more corrosion-resistant than post painted metal.

After the coil coating process, the coated metal may be processed, i.e., cut, in slit coils or plane sheets. There are two types of cutting, referred to as slitting, to produce slit coils: log slitting and rewind slitting. In log slitting the coil is treated as a whole (the “log”) and one or more slices are taken from it without an unrolling/re-reeling process. In rewind slitting, the web is unwound and run through a machine, passing through knives or lasers, before being rewound on one or more shafts to form narrower rolls. Sheets may be formed by further cutting the rolled metal strip forming the coil or the slit coil in the desired dimensions. Alternatively, the coated metal may be die-cut, saw-cut, or processed by other suitable means into desired shapes.

In some embodiments, the step of curing an at least partially or fully coated substrate forms a cured dry film with a film thickness of, for example, about 0.5 mil to about 6 mil, about 0.75 mil to about 5 mil, about 1 mil to about 4 mil, about 1.25 mil to about 3 mil, about 1.5 mil to about 2 mil. In some embodiments, the film thickness is about 0.5 mil, about 0.75 mil, about 1 mil, about 1.25 mil, about 2.5 mil, about 5 mil, or about 6 mil.

The step of curing can be performed, in some embodiments, at temperature in a range of from about 160° C. to about 300° C., about 180° C. to about 280° C., about 200° C. to about 260° C., or about 220° C. to about 240° C. In some embodiments, the step of curing can be performed at temperature of about 160° C., about 180° C., about 200° C., about 220° C., about 240° C., about 260° C., about 280° C., or about 300° C.

In some embodiments, the step of curing can be performed for a time in a range of about 10 seconds to about 50 seconds, about 15 seconds to about 45 seconds, about 20 seconds to about 40 seconds, about 25 seconds to about 35 seconds, or about 27.5 seconds to about 32.5 seconds. In some embodiments, the step of curing can be performed for a time of about 10 seconds, about 15 seconds, about 20 seconds, about 25 seconds, about 30 seconds, about 35 seconds, about 40 seconds, about 45 seconds, or about 50 seconds.

The fluoropolymer dispersion compositions may be applied to the substrates by any of a variety of methods including spraying, brushing, dipping, and roll coating, among other methods.

Also provided is a method of spray coating a substrate and the spray coated substrate. In the present spray coating method, a spray coating apparatus is used to apply the fluoropolymer dispersion composition. The fluoropolymer dispersion composition is often applied such that the wet film thickness is in range of about 1 mil to about 4 mil, about 1.5 mil to about 3.5 mil, about 1.75 mil to about 3.25 mil, about 2 mil to about 3 mil, or about 2.25 mil to about 2.75 mil. In some embodiments, the wet film thickness is about 1 mil, about 1.5 mil, about 2 mil, about 2.5 mil, about 3 mil, about 3.5 mil, about 4 mil.

In some embodiments, the coating is cured at a temperature in a range of about 200° C. to about 300° C., about 210° C. to about 290° C., about 220° C. to about 280° C., about 230° C. to about 270° C., or about 240° C. to about 260° C. In some embodiments, the coating is cured at a temperature of about 200° C., about 220° C., about 240° C., about 250° C., about 260° C., about 280° C., or about 300° C.

In some embodiments, the coating is cured for a time in a range of about 5 minutes to about 20 minutes, about 7.75 minutes to about 17.5 minutes, or about 10 minutes to about 15. In some embodiments, the step of curing can be performed for a time of about 5 minutes, about 10 minutes, about 15 minutes, or about 20 minutes.

In some embodiments, the coating is cured to form a cured dry film with a thickness in a range of about 0.3 mil to about 2 mil, about 0.5 mil to about 1.8 mil, about 0.7 mil to about 1.6 mil, about 0.9 mil to about 1.4 mil, about 1 mil to about 1.3 mil, or about 1.1 mil to about 1.2 mil. In some embodiments, the cured dry film has a film thickness of about 0.3 mil, about 0.5 mil, about 0.7 mil, about 0.9 mil, about 1 mil, about 1.1 mil, about 1.3 mil, about 1.5 mil, about 1.7 mil, about 1.9 mil, or about 2 mil.

### Dry Coated Film Compositions

Some embodiments are directed to dry coated film compositions comprising a PVF, an acrylic copolymer comprising amine and/or hydroxyl functional groups, and an isocyanate or a melamine crosslinker reactive groups that react with amino or hydroxyl functional groups; wherein the weight ratio of the acrylic copolymer to the PVF is in the range of about 0.05:1 to about 0.25:1; and wherein the number of reactive groups in the isocyanate or melamine crosslinker is about 75 to about 125 mol % relative to the total number of amine or hydroxyl functional groups in the acrylic copolymer.

Some embodiments are directed to dry coated film compositions comprising about 50 wt % to about 70 wt % PVF, about 3 wt % to about 10 wt % of an acrylic copolymer comprising amine and/or hydroxyl functional groups, and about 75 mol % to about 120 mol % of an isocyanate or a melamine crosslinker reactive groups relative to the amine and/or hydroxyl functional groups of the acrylic copolymer. In the dry coated film compositions, the sum of the weight percentages of the non-volatile components of the PVF coating composition is 100 wt %.

In some embodiments, the weight ratio of the acrylic copolymer to the PVF is in the range of about 0.05:1 to about 0.25:1, about 0.075:1 to about 0.225:1, about 0.10:1 to about 0.20:1, about 0.125:1 to about 0.175:1, or about 0.14:1 to about 0.16:1. In some embodiments, the weight ratio of the acrylic copolymer to the PVF is about 0.05:1, about 0.10:1, about 0.125:1, about 0.15:1, about 0.175:1, about 0.20:1, or about 0.25:1.

In some embodiments, PVF is present in the dry coated film composition in a range of about 50 wt % to about 70 wt %, about 52 wt % to about 68 wt %, about 55 wt % to about 65 wt %, about 58 wt % to about 62 wt %, or about 59 wt % to about 61 wt %. In some embodiments, PVF is present in the dry coated film composition in amount of about 50 wt %, about 55 wt %, about 60 wt %, about 65 wt %, or about 70 wt %.

In some embodiments, the acrylic copolymer is present in the dry coated film composition in a range of about 5 wt % to about 20 wt %, about 7 wt % to about 18 wt %, about 10 wt % to about 15 wt %, about 11 wt % to about 14 wt %, or about 12 wt % to about 13 wt %. In some embodiments, the acrylic copolymer is present in the dry coated film composition in amount of about 5 wt %, about 10 wt %, about 15 wt %, or about 20 wt %.

In some embodiments, the dry coated film composition is cured. Curing can be accomplished as discussed above.

The other components of the coating composition discussed above, namely isocyanate or a melamine crosslinker reactive groups, a pigment component, the acid scavenger epoxide component, the antioxidant component, and the solvent can be present in the dry coated film composition in amounts and combinations as discussed above for the coating composition. The cured composition differs from the dry coated film composition in that upon curing it comprises the reaction products of the acrylic resin and the crosslinker(s). It is not expected that the weights of the cured components differ significantly from those of the unreacted components. In the cured film composition, the sum of the weight percentages of the non-volatile components of the PVF coating composition is 100 wt %.

Applicant specifically incorporates the entire contents of all cited references in this disclosure. Further, when an amount, concentration, or other value or parameter is given as either a range or a list of upper values and lower values, this is to be understood as specifically disclosing all ranges formed from any pair of any upper range limit or value and any lower range limit or value, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

### EXAMPLES

The present disclosure is further defined in the following Examples. It should be understood that these Examples, while indicating exemplary embodiments of the present disclosure, are given by way of illustration only.

### Example 1

A series of PVF crosslinkable coating formulations were developed and tested for their adhesion to various primed or unprimed surfaces. The adhesion was measured by the cross-hatch cutter test (ASTM D3359). This test is fast and simple to perform with an inexpensive cross-hatch cutter test kit. A lattice pattern is cut into the finished film down to the substrate using a cross-hatch cutter. The test area is then brushed diagonally five times in each direction to remove any loose film finish particles. A special tape for testing adhesion is then firmly applied over the cross-hatch test area and removed quickly by pulling the tape from the test area to reveal the amount of coating lifted off by the test tape. The cross-hatched test area is then visually compared to ASTM standards D3359 showed below in Table 1.

TABLE 1

| ASTM D3359 | Percent area |
|---|---|
| classification | removed |
| 5B | 0% |
| 4B | <5% |
| 3B | 5-15% |
| 2B | 15-35% |
| 1B | 35-65% |
| 0B | >65% |

One regular non-crosslinked PVF coating formulation was tested without isocyanate crosslinker and one crosslinked PVF coating with isocyanate at around the same acrylics to PVF ratio at 15%. The detailed formulation is listed below in Table 2.

TABLE 2

| | Comparative | |
|---|---|---|
| | Example | Example 1 |
| PVF Topcoat formulation | wt % | wt % |
| PVF dispersion in propylene carbonate | 65 | 65.3 |
| 60% Titanium dioxide dispersion | 21 | 22.5 |
| Acrylic dispersion¹ | 11 | 8.8 |
| 33% Irganox ™ 1035 solution in 2- | 1 | 1.1 |
| butoxyethanol acetate (BEA) | | |
| Propylene carbonate | 2 | — |
| Isocyanate | — | 2.1 |
| Catalyst | — | 0.2 |
| Acrylics/PVF | 15 | 15 |
| Pigment/Binder | 40 | 40 |

¹30% Paraloid ™ B-44 acrylic polymer solution in propylene carbonate in comparative example available from The Dow Chemical Company of Midland, MI. In example 1, 50% Setalux DA-450-BA acrylic polymer solution in butyl acetate available from Allnex Resin Company.

Both the non-crosslinked PVF coating and the crosslinked PVF coating with nearly same formulation were applied to four different substrate surfaces (polyurethane primed galvanized steel, polyester primed galvanized steel, acrylics primed galvanized steel and unprimed galvanized steel). It was found that, by introducing isocyanate crosslinker to the PVF coating formulation, adhesion to these tested primed or unprimed substrate surface was improved as shown in Table 3.

TABLE 3

| | Comparative | |
|---|---|---|
| | Example 1 | Example 1 |
| Polyurethane | 2 B | 3 B |
| Polyester | 3 B | 5 B |
| Acrylics | 5 B | 5 B |
| Galvanized steel | 3 B | 5 B |

### Example 2

Four formulations with different acrylics to PVF ratios (10%, 15%, 20% and 25% acrylic) were further tested for their adhesion to polyurethane (PU) primer, polyester (PES) primer, acrylic primer and galvanized steel (Table 4 below). For PU, PES, and galvanized steel, more acrylic resin in the coating formulation resulted in stronger adhesion for both the non-crosslinked and the crosslinked coatings. The non-crosslinked PVF topcoat adhesion increased gradually from 0B to 5B when acrylics/PVF increased from 10% to 25%. The crosslinked coating followed the same trend as the non-crosslinked PVF topcoat, but at each formulation with certain acrylics to PVF ratio, crosslinked coating with isocyanate crosslinker showed higher adhesion compared with non-crosslinked PVF topcoat. This may be because most of the primers or unprimed metal surface have hydroxyl groups, and isocyanate in the crosslinked coating formulation can react with these hydroxyl groups to form urethane covalent bonds. The formed covalent bonds are stronger than the mechanical interlocking and/or intermolecular hydrogen bonding formed in the non-crosslinked topcoat.

TABLE 4

| Acrylics/PVF (wt %) | | 10 | 15 | 20 | 25 |
|---|---|---|---|---|---|
| Pigment/Binder (wt %) | | 40 | 40 | 40 | 40 |
| PU | non-crosslinked | 0 B | 2 B | 4 B | 5 B |
| | crosslinked | 2 B | 3 B | 5 B | 5 B |
| PES | non-crosslinked | 0 B | 3 B | 4 B | 5 B |
| | crosslinked | 1 B | 5 B | 5 B | 5 B |
| Acrylics | non-crosslinked | 5B | —¹ | — | — |
| | crosslinked | 5 B | 5 B | 5 B | 5 B |
| Galvanized | non-crosslinked | 0 B | 1 B | 5 B | 5 B |
| steel | crosslinked | 1 B | 5 B | 5 B | 5 B |

¹“—” means not measured.

### Example 3

A methyl ethyl ketone (MEK) rub test (ASTM D4752) for the non-crosslinkable PVF coating (formulation shown below) demonstrated that the blue pigment was extracted and the MEK left a white smear on the coating surface. This is possibly because the non-crosslinked acrylic carrying blue pigment was dissolved into MEK. The same MEK rub test was performed on the crosslinked PVF coating (formulation shown below), with the blue pigment extraction being less, and the white smear being less visible. The crosslinking of acrylics helped to retain the pigment within the polymeric network and permitted a lower level of polymer dissolution into the MEK.

TABLE 5

| | Comparative Example 3 | Example 3 |
|---|---|---|
| | Non-crosslinked PVF | Crosslinked PVF |
| | coating (g) | coating (g) |
| PVF dispersion in | 130 | 130 |
| propylene carbonate | | |
| TiO₂ dispersion | 9.3 | 10.4 |
| Acrylic resin type | B-44 (30%) | Seta DA-450 |
| Acrylic resin amount | 21.4 | 29.25 |
| 33% Irganox 1035 in BEA | 2 | 2.4 |
| Blue pigment dispersion | 10.4 | 11 |
| Catalyst | 0 | 0.6 |
| Isocyanate | 0 | 6.9 |

### Example 4

Thermal stability of PVF coatings was investigated by thermogravimetric analysis (TGA). PVF topcoat with different thermal stabilizer at different dosage (formulation shown in the Table 6 below; values are given as weight percentages based on the total weight of the PVF topcoat) was coated on bare metal and then stripped off from the metal panel. A sample weighing approximately 0.5 mg was cut from the stripped PVF film and loaded in the TGA (TA instrument, TGA 550). TGA was programmed to heat at 50° C./min and hold at 250° C. for ˜1 h.

TABLE 6

| | | | | | | Non- | Non- | |
|---|---|---|---|---|---|---|---|---|
| PVF Non- | | Non- | Non- | Non- | Non- | crosslinked | crosslinked | |
| crosslinked | Non- | crosslinked | crosslinked | crosslinked | crosslinked | PVF + | PVF + | Non- |
| topcoat | crosslinked | PVF + | PVF + | PVF + | PVF + | 1% Epon + | 2% Epon + | crosslinked |
| formulation | PVF wt % | 1% Epon | 2% Epon | 1% TPP | 2% TPP | 1% TPP | 2% TPP | PVDF |
| PVF | 65 | 65 | 65 | 65 | 65 | 65 | 64 | 65 |
| dispersion | | | | | | | | |
| (commercial | | | | | | | | |
| 44-1010) | | | | | | | | |
| 60% | 21 | 21 | 21 | 21 | 21 | 21 | 20 | 21 |
| Titanium | | | | | | | | |
| dioxide | | | | | | | | |
| dispersion | | | | | | | | |
| 30% | 11 | 11 | 11 | 11 | 11 | 11 | 11 | 11 |
| Paraloid ™ | | | | | | | | |
| B-44 | | | | | | | | |
| solution in | | | | | | | | |
| PC | | | | | | | | |
| 33% | 1 | 1 | 1 | 1 | 1 | 1 | 1 | 1 |
| Irganox ™ | | | | | | | | |
| 1035 | | | | | | | | |
| solution in | | | | | | | | |
| BEA | | | | | | | | |
| Propylene | 2 | 1 | ^{—1} | 1 | — | — | — | 2 |
| carbonate | | | | | | | | |
| Epon 828 | — | 1 | 2 | — | — | 1 | 2 | — |
| TPP | — | — | — | 1 | 2 | 1 | 2 | — |

¹“—” means not present.

Weight of the PVF sample was recorded in-situ as shown in Table 6 below. The decrease of sample weight indicated the instability and decomposition of the PVF sample. Usually, at 250° C. the sample weight stays constant for a period of time (stability time) and then weight decreases when the sample begins to decompose. A decrease in weight at a rate of greater than 5%/min is indicative of the end of the stable period. Non-crosslinked PVF base formulation (column 2) was studied as a control, which has stability time around 3 min. Adding TPP at 1% and 2% did not improve the stability. Adding 1% epoxide (Epon® epoxy resin 828) improved the stability time to ˜12 min. Additional epoxide (2%) has no effect on improving the stability. Epon® 828 and TPP showed a synergistic effect, as adding 1% Epon® 828 and 1% TPP made the PVF topcoat stable for ˜15 min. Non-crosslinked PVDF topcoat as a control showed no decomposition during the holding period of 1 hour at 250° C.

TABLE 7

| | | | | | | Non- | Non- |
|---|---|---|---|---|---|---|---|
| | | Non- | Non- | Non- | Non- | crosslinked | crosslinked |
| | Non- | crosslinked | crosslinked | crosslinked | crosslinked | PVF + | PVF + |
| | crosslinked | PVF + | PVF + | PVF + | PVF + | 1% Epon + | 2% Epon + |
| | PVF wt % | 1% Epon | 2% Epon | 1% TPP | 2% TPP | 1% TPP | 2% TPP |
| Stable time | 3.4 | 3.4 | 3.4 | 11.7 | 11.7 | 15 | 32 |
| (min) | | | | | | | |
| b* | 2.99 | 3.35 | 3.08 | −0.48 | −0.61 | −0.66 | −0.74 |

The color measurement of the coating at b* coordinate (blue/yellow) showed the correlation with the thermal stability time measured by TGA (Table 7). Low thermal stability samples had positive b* around 3, which is consistent with their yellowish color. Yellow color may be an indication that the PVF polymer decomposed. Adding Epon® 828 helped to improve the thermal stability and reduced the b* to negative (blue), which means less decomposition of PVF polymer.

### Example 5

The thermal stability of crosslinked PVF topcoat with different thermal stabilizers (formulation shown in Table 8 below; values are in units of grams (g)) was investigated by TGA following the same procedure as Example 4.

TABLE 8

| | | | | Cross- |
|---|---|---|---|---|
| | | Cross- | Cross- | linked |
| | Cross- | linked | linked | PVF + |
| | linked | PVF + | PVF + | 1% TPP + |
| Mix Recipe | PVF | 1% Epon | 1% TPP | 1% Epon |
| PVF dispersion (45 | 40 | 40 | 40 | 40 |
| wt % PVF resin in | | | | |
| propylene carbonate) | | | | |
| Acrylic solution | 3.60 | 3.60 | 3.60 | 3.60 |
| (Setalux BA-450) | | | | |
| Isocyanate | 0.84 | 0.84 | 0.84 | 0.84 |
| 1% catalyst solution | 0.07 | 0.07 | 0.07 | 0.07 |
| 33% Irganox 1035 in | 0.62 | 0.62 | 0.62 | 0.62 |
| BEA | | | | |
| TiO2 Dispersion | 13.2 | 13.2 | 13.2 | 13.2 |
| Epon 828 | | 0.6 | | 0.6 |
| Weston TPP | | | 0.6 | 0.6 |

Crosslinked PVF topcoat with isocyanate crosslinkers showed ˜5 min stable time before its weight decreased (Table 9 below). Epoxide (e.g., Epon® 828) added to the crosslinked PVF topcoat increased the stable time to 13 min. Adding 1% TPP also extended the stable time of crosslinked PVF topcoat to 20 min, which is different compared to the non-crosslinked PVF topcoat. Adding the combination of 1% Epon® 828 and 1% TPP showed the synergistic effect and had longest stable time at 25 min.

TABLE 9

| | | | | Crosslinked |
|---|---|---|---|---|
| | | Crosslinked | Crosslinked | PVF + |
| | Crosslinked | PVF + | PVF + | 1% TPP + |
| Mix Recipe | PVF | 1% Epon | 1% TPP | 1% Epon |
| Stable | 5 | 13 | 25 | 25 |
| time (min) | | | | |

### Example 6

The adhesion of thermally stable crosslinked PVF to various substrates can be further enhanced by increasing the acrylic to PVF ratio in the formulation. With the formulation showed in Table 10, the thermally stable PVF coating can achieve good adhesion (5B) to acrylic primer, polyester primer, polyurethane primer and bare metal following ASTM D3359 test. The thermal stability of this formulation cannot be directly measured by TGA because the coating cannot be stripped off from the substrates. As indirect evidence, the low b* value of this formulation verified good thermal stability of the sample.

TABLE 10
Mix Recipe

| | |
|---|---|
| PVF dispersion (45 wt % PVF resin in | 40 |
| propylene carbonate) | |
| Acrylic solution (Setalux BA-450) | 7.2 |
| Isocyanate | 1.69 |
| 1% catalyst solution | 0.14 |
| 33% Irganox 1035 in BEA | 0.69 |
| TiO2 Dispersion | 14.4 |
| Epon 828 | 0.6 |
| Weston TPP | 0.6 |

Adhesion

| | |
|---|---|
| Acrylic primer | 5B |
| Polyurethane primer | 5B |
| Polyesther primer | 5B |
| Bare metal | 5B |
| b* | −0.25 |

While certain of the preferred embodiments of this invention have been described and specifically exemplified above, it is not intended that the invention be limited to such embodiments. Various modifications may be made without departing from the scope and spirit of the invention, as set forth in the following claims.

What is claimed is:

1. A coating composition comprising:
(a) a polyvinyl fluoride (PVF);
(b) an acrylic copolymer comprising amine and/or hydroxyl functional groups; and
(c) an isocyanate or a melamine crosslinker with reactive groups that react with amino or hydroxyl functional groups, wherein:
the weight ratio of the acrylic copolymer to the PVF is in the range of 0.05:1 to 0.25:1; and
the number of reactive groups in the isocyanate or melamine crosslinker is 75 to 125 mol % relative to the total number of amine or hydroxyl functional groups in the acrylic copolymer.

2. The coating composition of claim 1, further comprising a pigment component, wherein the weight ratio of the pigment component to the total weight of PVF and acrylic copolymer in the coating composition is in a range of 0.05:1 to 0.25:1.

3. The coating composition of claim 1, further comprising an acid scavenger epoxide component, wherein the weight ratio of the acid scavenger epoxide component to the PVF is in the range of 0.002:1 to 0.1:1.

4. The coating composition of claim 1, further comprising an antioxidant component, wherein the weight ratio of antioxidant component to the PVF is in the range of 0.002:1 to 0.1:1.

5. The coating composition of claim 4, wherein the antioxidant component is a phosphate-based antioxidant or a phenolic antioxidant.

6. The coating composition of claim 1, further comprising one or more solvents wherein the weight ratio of the solvents to the PVF is in the range of 2:1 to 1:1.

7. A substrate at least partially coated by the coating composition of claim 1.

8. The substrate of claim 7, wherein the coated surface of the substrate is primed.

9. The substrate of claim 8, wherein a primer is a polyurethane, a polyester, or an acrylic primer.

10. The substrate of claim 7, wherein the coated surface of the substrate is a metal.

11. The substrate of claim 7, wherein the coated surface of the substrate is a cured layer of the coating composition of claim 1.

12. A dry coated film composition comprising
(a) a polyvinyl fluoride (PVF);
(b) an acrylic copolymer comprising amine and/or hydroxyl functional groups; and
(c) an isocyanate or a melamine crosslinker reactive groups that react with amino or hydroxyl functional groups, wherein:
the weight ratio of the acrylic copolymer to the PVF is in the range of 0.05:1 to 0.25:1; and
the number of reactive groups in the isocyanate or melamine crosslinker is 75 to 125 mol % relative to the total number of amine or hydroxyl functional groups in the acrylic copolymer.

13. The dry coated film composition of claim 12 that is coated on at least a portion of a primed substrate or a metal substrate.

14. The dry coated film composition of claim 13, wherein a primer is a polyurethane, a polyester, or an acrylic primer.

15. The dry coated film composition of claim 12 that is cured.

16. A method of coating a substrate comprising applying the coating composition of claim 1 to at least a portion of a substrate.

17. The method of claim 16, wherein the substrate is coil coated with the coating composition.

18. The method of claim 16, further comprising the step of curing the coating composition.

19. The method of claim 16, wherein the substrate is primed.
